(19) United States
(12) Patent Application Publication
(10) Pub. No.: US 2012/0075885 A1
(43) Pub. Date: Mar. 29, 2012

(54) BACKLIGHT FOR LARGE FORMAT ILLUMINATION

(75) Inventor: Jeffrey Brian Sampsell, Pueblo West, CO (US)

(73) Assignee: Qualcomm MEMS Technologies, Inc.

(21) Appl. No.: 12/890,284

(22) Filed: Sep. 24, 2010

(51) Int. Cl. F21V 7/04; H01J 9/00

(52) U.S. Cl. 362/609; 445/23; 445/66

(57) ABSTRACT

The present disclosure provides systems, methods and apparatus, including computer programs encoded on computer storage media, for illuminating films with one or more backlights. In one aspect, a side-illuminated backlight may include a reflective back sheet and a reflective front sheet with a plurality of perforations. The size and spacing of the perforations may be configured for producing a field of light, via the plurality of perforations, having a uniformity that is within a predetermined range. The side-illuminated backlight may also include a rigid reflective frame having a window on at least one side through which light may be received. The backlight may include a light-turning film for re-directing at least some light emerging from the front sheet perforations. The light-turning film may direct light entering the perforations in the front sheet at an oblique angle to a more nearly perpendicular angle relative to the front sheet.

### TECHNICAL FIELD

This disclosure relates generally to display technology and more specifically to the illumination of displays.

### BACKGROUND

Large-area images or non-representational patterns may be created by programmable displays or they may be reproduced as fixed images applied to thin transparent or translucent media. These images are often used for ornamental, decorative, or promotional purposes. Some examples include the large, illuminated films that are commonly seen in airports, which may be as large as 4 feet by 8 feet, or larger. Typically, such displays are illuminated by an array of fluorescent lights.

Such displays tend to be bulky and heavy. Moreover, the lighting produced by the fluorescent lights is not uniform even if all of the fluorescent lights are functioning properly. As the fluorescent lights reach the end of their usable lifetime, they often become dimmer and tend to flicker. Monitoring and replacing the fluorescent lights, their ballasts, etc., can add substantially to the cost of maintaining this type of large-format backlight. It would be desirable to provide improved lighting for large-format displays.

### SUMMARY

Improved methods and devices are provided for large-format display illumination. Some implementations described herein provide a side-illuminated backlight. Instead of using a solid illumination layer such as that used in smaller, conventional backlights, some side-illuminated backlights include a hollow, air-filled box. Such implementations can greatly reduce the weight and cost of simply scaling up the solid illumination layers of the prior art.

One implementation of such a side-illuminated backlight includes a thin, highly reflective back sheet and a similar front sheet with a plurality of perforations. The size and spacing of the perforations may be configured for producing a field of light, via the plurality of perforations, having a uniformity that is within a predetermined range. Alternatively, or additionally, the size and spacing of the perforations may be configured to achieve at least a predetermined level of light extraction from a cavity formed by the backlight. The size and spacing of the perforations may, for example, be defined by a ray-trace simulation such as a Monte Carlo ray-trace simulation. The side-illuminated backlight also can include a four-sided rigid reflective frame having a window on one side of the frame into which light from a light source may enter a cavity formed by the interior surfaces of the backlight.

The side-illuminated backlight may include one or more light management elements, such as a light-turning layer configured to re-direct at least some light that emerges from the perforations in the front sheet. In some such implementations, the light-turning layer may direct light entering the perforations in the front sheet at an oblique angle to a substantially perpendicular angle (relative to the front sheet). The backlight may also include a diffusing layer.

The backlight may include a plurality of support struts affixed to the back sheet and/or the front sheet and extending between the back sheet and the front sheet. The support struts may be substantially transparent. The size and positions of the support struts may be selected such that the field of light produced via the plurality of perforations has a uniformity that is within a predetermined range and/or to obtain at least a predetermined level of light extraction from a cavity formed by the backlight.

Some implementations described herein provide a backlight that includes the following elements: a first side having a first width and configured to receive light from a light source; second, third and fourth sides having substantially the first width, the first through fourth sides forming a substantially rigid frame, the second through fourth sides having reflective interior surfaces that are configured to reflect light from the light source; a first reflective film attached to a first side of the frame; and a second reflective film attached to a second side of the frame. The second reflective film may have a plurality of perforations. The first and second reflective films may define a cavity within the frame.

The backlight may include at least one light source. The size and spacing of the perforations may be configured for producing a field of light for a display via the plurality of perforations, the field of light having a uniformity of irradiance that exceeds a threshold level. A display may include at least a portion of the backlight.

The backlight may also include a light-turning film configured to re-direct at least some light that emerges from the perforations in the second reflective film. The light-turning film may be configured to re-direct at least some light that emerges from the perforations such that the light emerges from the light-turning film along an axis that is substantially perpendicular to the second reflective film. The backlight may include a diffusing film. In some implementations, the light-turning film may be disposed between the diffusing film and the second reflective film.

The backlight may include a plurality of support struts affixed to the first reflective film and extending between the first and second reflective films. The support struts may be substantially transparent. The support struts may also be affixed to the second reflective film.

A first side of the second reflective film may be attached to the second side of the frame. A second side of the second reflective film may face away from the frame. The backlight may also include a diffusing film disposed proximate the second side of the second reflective film.

The size and spacing of the perforations may also be configured to achieve at least a threshold level of light extraction from a cavity formed by the backlight. The backlight may also include reinforcing material for at least some of the perforations. For example, the backlight may include a substantially transparent sheet of reinforcing material affixed to the second reflective film.

Various methods are described herein. Some such methods include the following processes: assembling a four-sided frame having reflective inner surfaces, one side of the frame having a window configured to receive light from a light source; attaching a first reflective film to a first side of the frame; forming a plurality of perforations in a second reflective film; and attaching the second reflective film to a second side of the frame. The method may involve attaching a light source to the window. The forming process may involve forming the perforations such that a field of light emanating from the plurality of perforations has a uniformity of irradiance that exceeds a threshold level.

The method may involve attaching a light-turning film to an exterior surface of the second reflective film. The light-turning film may be configured to re-direct at least some light that emerges from the perforations. The method may include disposing a diffusing film adjacent to the light-turning film. The light-turning film may be configured to re-direct at least some light that emerges from the perforations such that the light emerges from the light-turning film along an axis that is substantially perpendicular to the second reflective film. The method may involve affixing a plurality of support struts to the first reflective film and/or to the second reflective film.

The forming process may involve forming the perforations to achieve at least a predetermined level of light extraction from a cavity formed by the frame, the first reflective film and the second reflective film. The forming process may involve a mechanical cutting process, a laser cutting process and/or an etching process. The forming process may involve forming perforations that extend through only a portion of the second reflective layer.

The method may involve applying reinforcing material to at least some perforations. The applying process may involve attaching substantially transparent disks of reinforcing material to at least some perforations. The applying process may involve attaching a substantially transparent layer of reinforcing material to the second reflective film.

These and other methods may be implemented by various types of devices, systems, components, software, firmware, etc. For example, some features of the disclosure may be implemented, at least in part, by computer programs embodied in machine-readable media. Some such computer programs may, for example, include instructions for determining the size and/or orientation of the perforations in the second reflective layer. Some computer programs may include instructions for controlling a perforation system to make the perforations. Some computer programs may include instructions for determining the size and/or orientation of support struts. Some computer programs may include instructions for controlling an assembly system to assemble at least part of a large-format backlight.

Accordingly, some implementations involve a tangible medium having software stored thereon. For example, the software may include instructions for controlling at least one device to form a plurality of perforations in a first reflective film. The software may include instructions for forming the plurality of perforations such that a field of light emanating from a backlight through the plurality of perforations has a uniformity of irradiance that exceeds a threshold level.

The software may include instructions for controlling the at least one device to assemble a four-sided frame having reflective inner surfaces, one side of the frame having a window configured to receive light from a light source, to attach the first reflective film to a first side of the frame and to attach a second reflective film to a second side of the frame. The software may include instructions for controlling the at least one device to attach a light-turning film to an exterior surface of the first reflective film. The light-turning film may be configured to re-direct at least some light that emerges from the perforations. The software may include instructions for controlling at least one device to affix a plurality of support struts to the first reflective film.

Some implementations provide a device or system that includes the following elements: apparatus for assembling a four-sided frame having reflective inner surfaces, one side of the frame having a window configured to receive light from a light source; apparatus for attaching a light source to the window; apparatus for forming a plurality of perforations in a first reflective film; and apparatus for attaching the first reflective film to a first side of the frame and for attaching the second reflective film to a second side of the frame. The forming apparatus may include apparatus for forming the plurality of perforations such that a field of light emanating from the plurality of perforations has a uniformity of irradiance that exceeds a threshold level.

The attaching apparatus may be configured for attaching a light-turning film to an exterior surface of the first reflective film. The light-turning film may be configured to re-direct at least some light that emerges from the perforations. The device or system may also include apparatus for affixing a plurality of support struts to the second reflective film.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 depicts a simplified version of a side-illuminated backlight as described herein.

FIG. 2 is an exploded view of a side-illuminated backlight such as that depicted in FIG. 1.

FIG. 3 illustrates a portion of one implementation of a side-illuminated backlight having support struts attached to an interior surface of a reflective layer.

FIG. 4 depicts a cross-sectional view of a light ray emerging from a perforation in a front reflective layer of a side-illuminated backlight at an oblique angle relative to the front reflective layer, passing through a light-turning layer and leaving the backlight at a substantially perpendicular angle.

FIG. 5 is a flow chart that indicates steps in a process of fabricating some front side-illuminated backlights described herein.

FIG. 6 is a block diagram that illustrates a control system for determining the size and/or orientation of the perforations in the front reflective layer, a perforation system for making the perforations and an assembly system for assembling at least part of a large-format backlight.

FIG. 7 depicts dimensions and other parameters that may be used as input for simulations of a backlight as described herein.

FIG. 8 depicts modeling results of a first backlight simulation based on a first set of parameters.

FIG. 9 depicts modeling results of a second backlight simulation based on a second set of parameters.

FIG. 10 depicts modeling results of a third backlight simulation based on a third set of parameters.

FIG. 11A depicts a backlight having internal support struts.

FIG. 11B depicts modeling results of a fourth backlight simulation based on a fourth set of parameters, including parameters for the internal support struts depicted in FIG. 11A.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

Improved large-format backlights are described herein. Some such backlights are suitable for illuminating large films such as those that are commonly seen in airports and other public spaces. Such films may be 4 feet by 8 feet or larger and are normally illuminated by a series of fluorescent lights. Not only are such displays bulky and heavy, but the lighting produced by the fluorescent lights is not uniform even if all of the fluorescent lights are functioning properly.

In recent years, a substantial amount of research and development has been focused on the development of backlights for personal computers, hand-held devices, etc. The main optical component of the laptop and monitor backlights is a rectangular acrylic slab that may be as thin as 2-3 mm for a 12 inch display (measured on the diagonal). If this acrylic slab were scaled to a 4 foot by 8 foot form factor, the acrylic slab would weigh on the order of 100 pounds. Consequently, the use of such backlighting is limited to installations that can provide a structure to support such large weights.

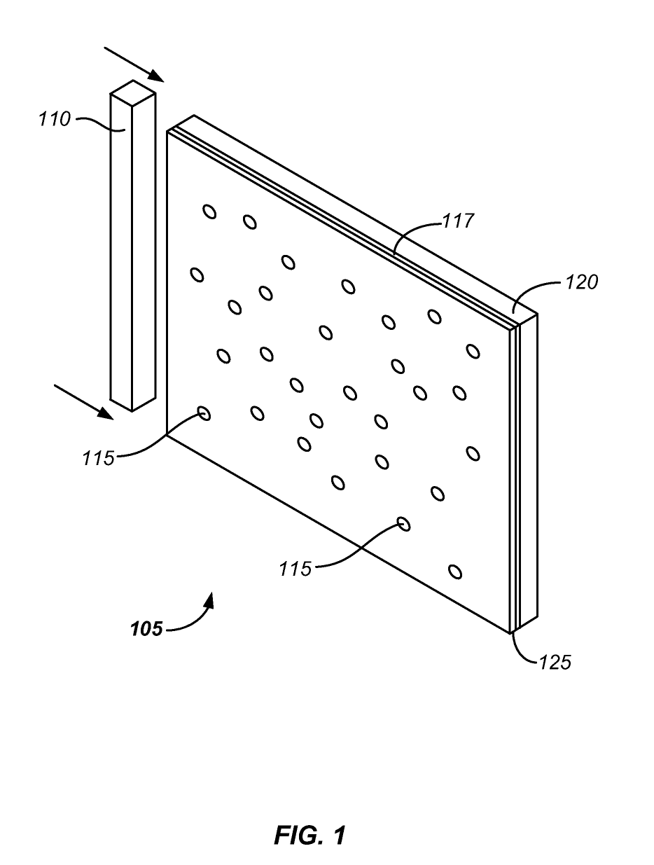

Some implementations described herein provide a side-illuminated backlight that includes a hollow, air-filled box. Such implementations greatly reduce the weight and cost of simply scaling up the solid illumination layers of the prior art. Some such backlights will now be described with reference to FIG. 1 et seq.

FIG. 1 depicts a simplified version of a side-illuminated backlight 105. Here, frame 120 provides structural support for backlight 105. Frame 120 may be formed of any appropriate material that is durable and substantially rigid, such as plastic, metal, wood, etc. In some implementations, frame 120 is formed of aluminum. The dimensions of frame 120 may vary substantially according to the desired implementation. In some examples, frame 120 is made such that backlight 105 will have a common “form factor,” such as 8 feet long by 4 feet wide by one inch deep. The width of frame 120 may be chosen to achieve the desired depth of backlight 105.

In this example, front reflective layer 117 is disposed on frame 120. Front reflective layer 117 may be formed of any suitable highly reflective material. In some implementations, front reflective layer 117 may include a polymer film having a more reflective film disposed thereon, such as aluminized polyethylene terephthalate (“PET”). The more reflective surface should be facing the inside of backlight 105. In some implementations, the polymer film may be translucent or substantially transparent.

The other surfaces that form the interior of backlight 105 should also be reflective. Therefore, in addition to the reflective inner surface of front reflective layer 117, the inside surfaces of frame 120 and the interior surface of the rear portion of backlight 105 should also be reflective.

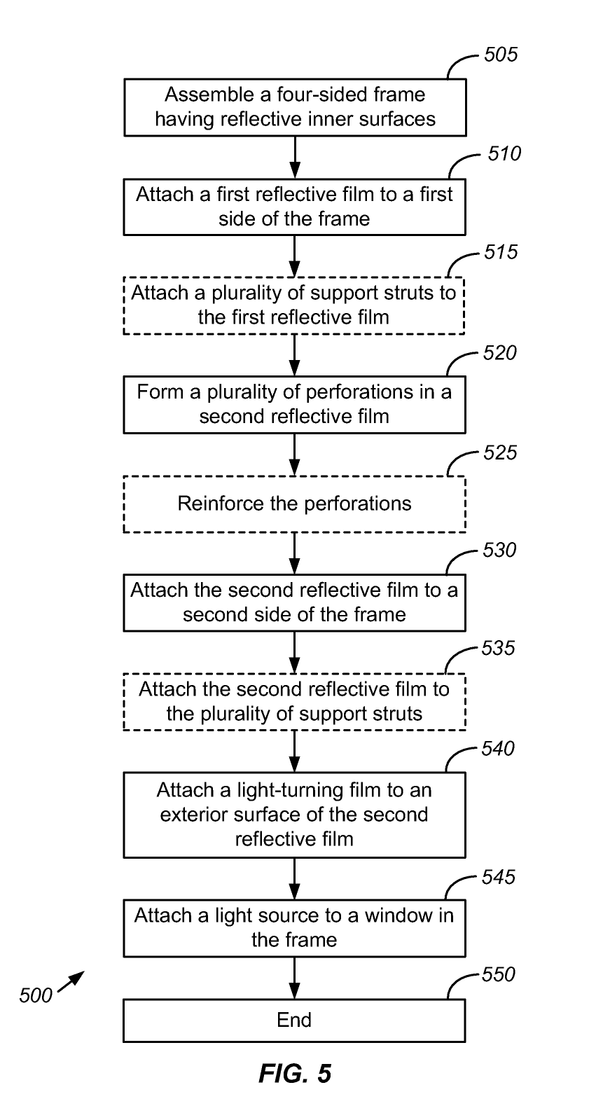

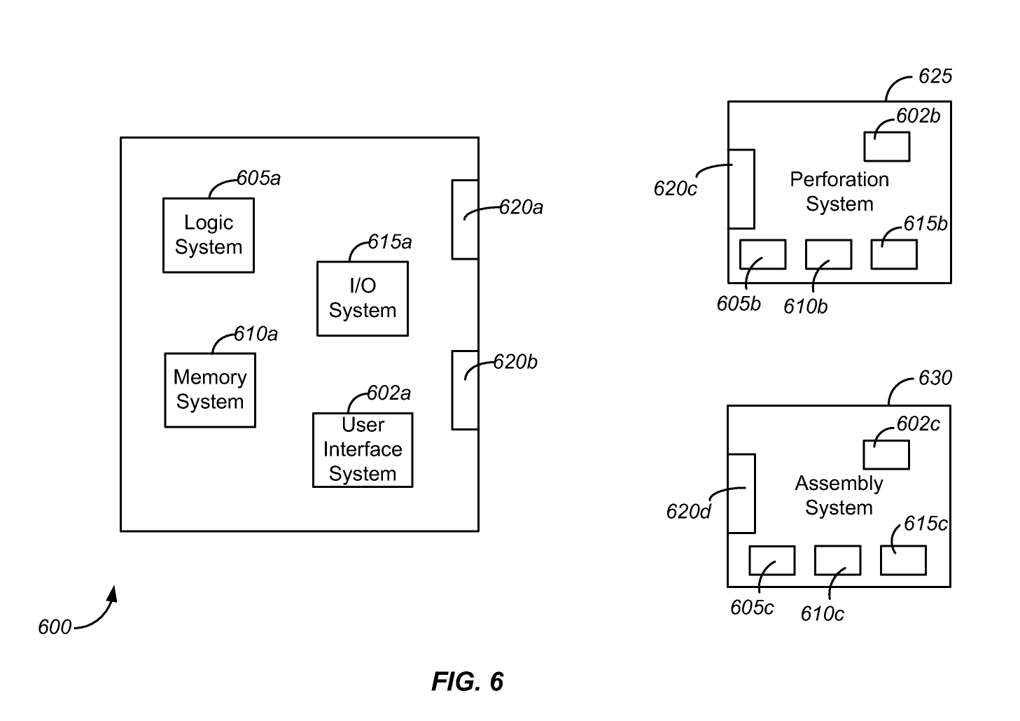

Light emerges from the interior of backlight 105 through perforations 115 in front reflective layer 117. In FIG. 1, perforations 115 are visible through light-turning layer 125. Perforations 115 may be formed in any suitable manner. Some examples are described below with reference to FIGS. 5 and 6.

The size and spacing of perforations 115 may be selected such that backlight 105 can provide acceptable illumination for a display. In some implementations, the determination of what is an acceptable illumination for the display may be based, at least in part, on subjective criteria. Such determinations may be made according to the judgment of one or more, e.g., human observers, or computer programming criteria.

However, in some implementations the determination of what is an acceptable illumination for the display may be based, at least in part, on objective criteria. One such criterion may be the spatial variation in actual or theoretical irradiance of the display caused by backlight 105. For example, a plane in which the display would be disposed may be divided into a grid. The variation in actual or theoretical irradiance of different areas of the grid may be determined for a given size and spacing of perforations 115. If the variation is determined to be unacceptable, e.g., if the variation exceeds a predetermined threshold, the size and spacing of perforations 115 may be altered and the variation in actual or theoretical irradiance may be determined once again.

Due to the way human vision works, smooth monotonic variations of intensity across large areas may be tolerated whereas smooth variations that include inflection points might be found objectionable. For example, some people might tolerate a display that rolls off significantly in brightness near its edges, but might not tolerate a display that rolls off as it approaches the edges and then rolls back on before reaching the edge. Such global variations may be objectionable even though the local variations in brightness may be smooth and well within tolerance.

In some implementations, a larger variation of irradiance values may be tolerated in predetermined parts of the display, e.g., in “edge” areas of the grid that are within a predetermined distance from a display edge. In some such implementations, irradiance values corresponding to such edge areas may be treated differently from irradiance values corresponding to interior areas. For example, irradiance values corresponding to such edge areas may be smoothed, a weighting function may apply a lower weight to values corresponding to edge areas, or such values may be excluded from the calculation of irradiance variation.

The size and spacing of perforations 115 may, for example, be determined by a ray-trace simulation. In some implementations, the ray-trace simulation can include a Monte Carlo ray-trace simulation. In some implementations, the size and spacing of the perforations may be determined using software such as the Advanced Systems Analysis Program (“ASAP”) provided by Breault Research. The dimensions, reflectivity or reflectance, and other parameters of the cavity may be input, as well as the position and characteristics of the light source. Other parameters, such as the optical effects of support struts and/or the optical effects of light management elements, may be input. Based on these parameters, various arrangements and/or sizes of perforations 115 may be modeled.

The process may be repeated until backlight 105 can provide acceptable illumination for a display. For example, the process may be repeated until a field of light for the display is produced, via the plurality of perforations, having a uniformity of irradiance that is within a predetermined range and/or above a threshold level. Some examples of how uniformity of irradiance may be determined for various configurations of backlight 105 are described below. Uniformity of irradiance may be quantified in any convenient manner. However, in these examples, uniformity of irradiance is expressed as a percentage. The percentage may, for example, represent the percentage of the display area having a flux per unit area that is within a range of an average value, within a range of a maximum value, within a range of a minimum value, etc. Accordingly, the predetermined range may depend, at least in part, on the criteria used to determine the uniformity of irradiance.

Edge areas may be treated differently from interior areas, or may not be included in the irradiance determination. In addition to evaluating smoothness in local irradiance variations, factors involving human vision may be evaluated. For example, a model that results in lighting that is brighter in the central portion of the display but dimmer near the edges may be acceptable, whereas a model that results in lighting that is dimmer in the central portion of the display and brighter near the edges may not be acceptable. Model results may be evaluated to detect inflection points that may be objectionable to a human observer.

Alternatively, or additionally, the process may be repeated until the size and spacing of the perforations are configured to achieve at least a predetermined level of light extraction from the cavity formed by backlight 105. The predetermined level of light extraction may, for example, be established with reference to a percentage of the light that is provided to backlight 105 by light source 110. Some examples of such modeling processes are described in more detail below.

Here, frame 120 is configured to receive light source 110. Light source 110 may include, for example, a conventional fluorescent lamp, a cold cathode fluorescent lamp, an array of light-emitting diodes (“LEDs”), or a linear strip of organic light emitting diode (“OLED”) material. Light source 110 may include a formed metal or polymer housing formed of a reflective material or lined with a reflective layer. In some implementations, the reflective layer may be made of the same material as that of the front reflective layer 117 and/or a back reflective layer.

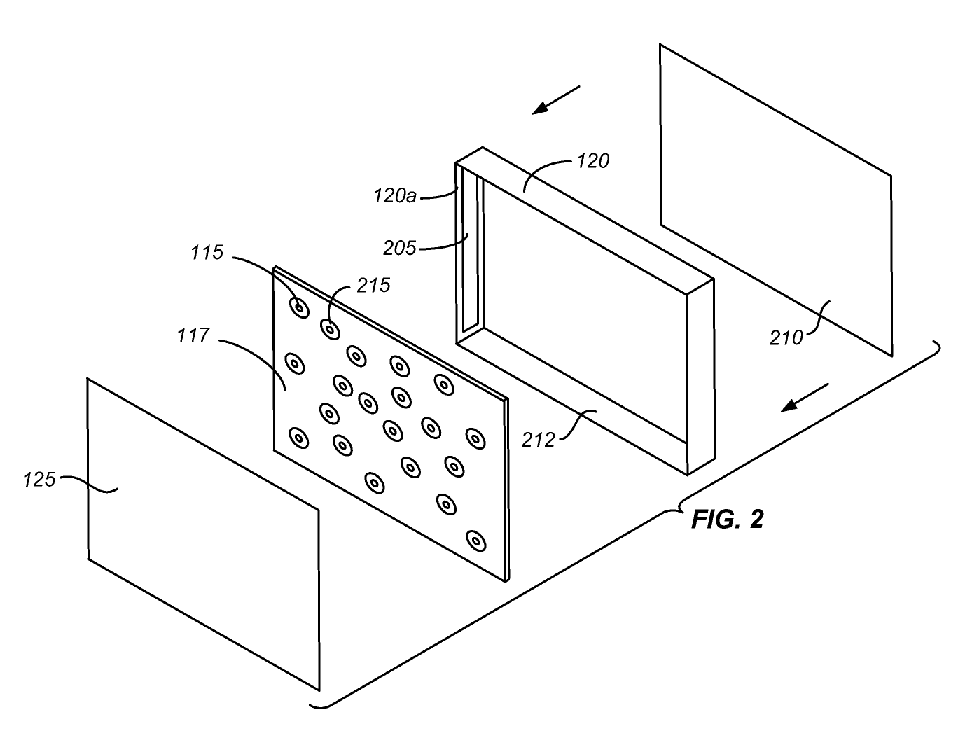

FIG. 2 is an exploded view of a side-illuminated backlight 105 such as that depicted in FIG. 1. In this drawing, back reflective layer 210 may be seen, as well as interior reflective sides 212 of frame 120. Side 120a of frame 120 includes window 205 through which light from light source 110 may enter the cavity formed by the interior of backlight 105. In some implementations, window 205 may include an opening, whereas in other implementations window 205 may be enclosed by substantially transparent material, such as acrylic or other plastic material, glass, etc. In some other implementations, window 205 may include a film, such as a light-diffusing film. The window 205 may also include one or more optical elements, such as one or more reflectors, lenses or other optical elements. Alternatively, or additionally, light source 110 may include one or more of such optical elements.

Perforations 115 may or may not extend completely through front reflective layer 117. However, for implementations in which perforations 115 do extend completely through front reflective layer 117, the perforations 115 can be strengthened. In the implementation depicted in FIG. 2, the edges of perforations 115 are strengthened by reinforcements 215.

Reinforcements 215 may be applied before or after perforations 115 are formed in front reflective layer 117. Moreover, perforations 115 may or may not extend through reinforcements 215. In some implementations, reinforcements 215 may include substantially transparent disks that are applied to the areas of front reflective layer 117 in which perforations 115 will be, or have been, formed. In alternative implementations, reinforcements 215 may include doughnut-shaped elements. Some examples of forming reinforcements 215 are described below with reference to FIG. 5.

When backlight 105 is in operation, light is injected into the cavity from light source 110 via window 205 in frame portion 120a. The light may reflect multiple times between interior reflective sides 212 of frame 120, front reflective layer 117 and back reflective layer 210 as it travels across the long dimensions of the cavity formed by the interior surfaces of backlight 105. Some of the light can escape from the cavity through perforations 115.

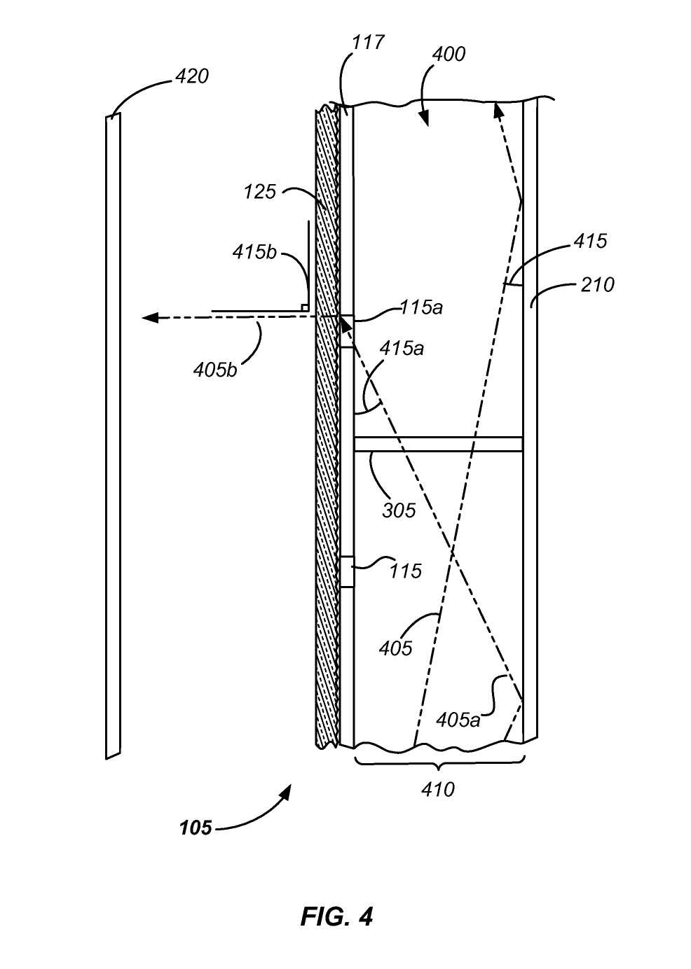

In some implementations, a diffusing film, a more complex angle management film or both may be used to modify the light field produced by light emitted from perforations 115. One or more such films may be disposed on an outer surface of front reflective layer 117. In the example depicted in FIG. 1, light-turning film 125 is affixed to the outer surface of front reflective layer 117. As described in more detail below with reference to FIG. 4, light-turning film 125 can modify and direct the light exiting from perforations 115. Light-turning film 125 may, for example, include a prism film that is positioned with its prism points facing toward back reflective layer 210. In such implementations, turning light toward the normal direction of propagation may implement a significant increase in the percentage of light propagating in a direction that is substantially normal to the emitting surface while substantially reducing the amount of light propagating in oblique directions. Mechanical vibration of backlight 105 may lead to temporal variation in the light emitted through front reflective layer 117. Such vibrations may be more pronounced in front reflective layer 117 and/or back reflective layer 210 than in frame 120, because frame 120 will generally be more rigid. Mechanical vibration of backlight 105 may be more pronounced in locations where backlight 105 is exposed to air currents, vibrations or other such environmental effects.

The potential effects of mechanical vibrations may be mitigated in various ways. In some implementations, front reflective layer 117 and/or back reflective layer 210 may be made relatively thicker. For example, front reflective layer 117 and/or back reflective layer 210 may be made thicker than a standard sheet of Mylar™, which is approximately 0.001 inch thick. In some such implementations, two or more sheets of PET or a similar material may be used to form front reflective layer 117 and/or back reflective layer 210. Only the side facing the inside of backlight 105 would need to be reflective. Such implementations would require relatively more material and therefore be relatively heavier and more expensive than implementations having relatively thinner front and/or back films.

Alternatively, or additionally, front reflective layer 117 and/or back reflective layer 210 may be stretched tightly onto frame 120. In such implementations, frame 120 may need to be made relatively stronger and would generally be heavier. Again, such implementations of backlight 105 would require relatively more material and therefore be relatively heavier and more expensive.

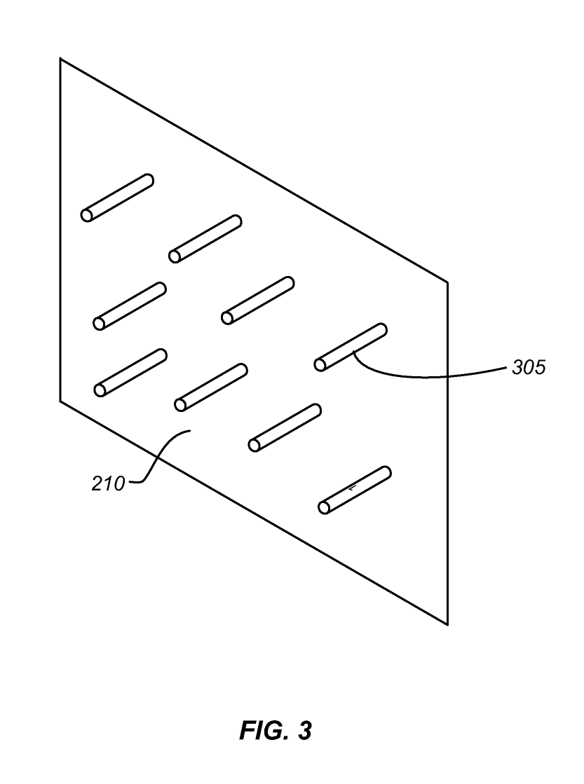

FIG. 3 illustrates a portion of one implementation of a side-illuminated backlight having support struts 305 attached to an interior surface of a reflective layer. This FIG. illustrates another approach to reducing the potential effects of mechanical vibrations. As shown in FIG. 3, support struts 305 may be attached to back reflective layer 210. In this example, support struts 305 include substantially transparent rods of a length approximately equal to the cavity thickness. As such, support struts 305 can extend from back reflective layer 210 to front reflective layer 117. Support struts 305 can significantly dampen the mechanical vibrations of back reflective layer 210 and front reflective layer 117. In some implementations, support struts 305 may be attached to both back reflective layer 210 and front reflective layer 117.

Support struts 305 may be made of any suitable material. For example, and without limitation, support struts 305 may be made of a plastic material such as acrylic. If so desired, support struts 305 may be configured to minimally disturb the paths of light rays propagating within backlight 105. However, in alternative implementations, at least some of support struts 305 may be configured to reflect and/or scatter incident light. The optical effects caused by support struts 305 are preferably taken into account during the ray-trace simulations that are used to determine the locations and/or sizes of perforations 115.

FIG. 4 depicts a cross-sectional view of a light ray emerging from a perforation in a front reflective layer of a side-illuminated backlight 105 at an oblique angle relative to the front reflective layer, passing through a light-turning layer and leaving the backlight at a substantially perpendicular angle. Although there is a gap between display 420 and backlight 105 in the example shown in FIG. 4, in alternative implementations display 420 may be disposed adjacent to backlight 105.

In this implementation, backlight 105 includes a plurality of support struts 305, one of which is shown in FIG. 4. Support struts 305 extend from front reflective layer 117 to back reflective layer 210 and dampen the mechanical vibrations of back reflective layer 210 and front reflective layer 117.

Light, depicted here as light rays 405, reflects from the reflective surfaces inside cavity 400. In some implementations, the length and width of backlight 105 are significantly greater than the depth 410 of cavity 400. Accordingly, light rays 405 reflect from front reflective layer 117 and back reflective layer 210 at relatively small angles 415 relative to these surfaces. Light ray 405a emerges from perforation 115a at a small angle 415a relative to front reflective layer 117.

However, it is desirable to direct a substantial portion of the light that emerges from perforations 115 towards display 420 at angles that are within a predetermined range of angles from the normal to display 420. Therefore, it is desirable to have one or more light management elements disposed between front reflective layer 117 and display 420. In the example depicted in FIG. 4, light-turning film 125 is affixed to the outer surface of front reflective layer 117. Here, light-turning film 125 includes a prism film that is positioned with its prism points facing towards front reflective layer 117.

Light-turning film 125 can be configured to receive light rays 405 exiting from perforations 115 at a variety of angles relative to the surfaces of light-turning film 125 and front reflective layer 117. Light-turning film 125 is further configured to re-direct light rays 405 to angles that are substantially perpendicular to light-turning film 125, front reflective layer 117 and/or display 420. As used herein, the term “substantially perpendicular” means within a predetermined range of angles from the normal. Depending on the implementation, this predetermined range may be +/−5 degrees, +/−10 degrees, +/−15 degrees, +/−20 degrees, or another predetermined angle range.

In this example, light-turning film 125 receives light ray 405a at a small angle 415 a relative to the surfaces of light-turning film 125 and front reflective layer 117. Re-directed light ray 405b emerges from light-turning film 125 at an angle that is substantially perpendicular to the outer surface of light-turning film 125 and substantially perpendicular to display 420.

FIG. 5 is a flow chart that indicates steps in a process 500 of fabricating some front side-illuminated backlights described herein. As with other methods described herein, the steps of method 500 are not necessarily performed in the order indicated. For example, perforations may be formed in a front reflective film before the other steps are performed. Moreover, in some implementations the front reflective film may be attached to the frame before the back reflective film is attached, or at substantially the same time that the back reflective film is attached.

However, in this implementation of method 500 a backlight frame is constructed first: in step 505, a four sided frame is assembled. The frame has reflective inner surfaces, such as surfaces 212 of frame 120 (see FIG. 2). Such surfaces may be reflective due to the properties of the frame material or a separate reflective material may be added to the interior surfaces of the frame. The process of assembling the frame will depend on the type of materials involved and whether the frame is formed from multiple components. In some implementations, for example, the frame may include a plastic or metal structure that is cast (or otherwise formed) as a single component. In alternative implementations, multiple frame components may be joined together in step 505. In this example, a side portion of the frame is formed with a window configured for receiving a light source, such as window 205 shown in FIG. 2.

In step 510, a first reflective film is attached to a first side of the frame. In this example, the first reflective film is a back reflective film such as back reflective film 210 (see FIG. 2). In some implementations, the first reflective film may be stretched across the first side of the frame in order to provide increased rigidity and resistance to mechanical vibrations.

In optional step 515, a plurality of support struts are attached to the first reflective film. These support struts may be similar to support struts 305, described above with reference to FIG. 3. However, the support struts are not necessarily cylindrical in shape: other sizes, shapes and distributions of support struts are contemplated by the inventor. The support struts may be attached to the first reflective film in any suitable manner, such as by bonding the support struts to the first reflective film with an adhesive material. In alternative implementations, support struts may be attached to the first reflective film before the first reflective film is attached to the frame.

In step 520, perforations (such as perforations 115 described above) are formed in a second reflective film, which is an implementation of front reflective layer 117 in this example. The perforations may be formed in a variety of ways, depending on the desired implementation. In some implementations, the perforations are formed by a mechanical process such as die cutting. In other implementations, the perforations are formed by an optical process such as laser cutting. In alternative implementations, the perforations may be formed by selectively removing the reflective portion of the second reflective film in the areas of the perforations, leaving only substantially transparent areas. For example, the reflective portion of the second reflective film could be selectively removed via an etching process. As such, the perforations may not necessarily extend completely through the second reflective film.

In optional step 525, the perforations are then reinforced. For example, reinforcements 215 as described above may be adhesively applied to the front reflective film over or around the perforations. However, depending on the implementation, reinforcements may be applied before or after the perforations are formed in the second reflective film. In some implementations, the reinforcements may include substantially transparent disks that are applied to the areas of the second reflective film in which the perforations will be, or have been, formed.

In alternative implementations, reinforcement may be provided by one or more sheets of substantially transparent material that is applied to the second reflective film. In some such implementations, reinforcement may be provided by a single sheet of substantially transparent material that has substantially the same dimensions as the second reflective film. In some implementations, reinforcement may be provided by a sheet of light-diffusing film that has substantially the same dimensions as the second reflective film.

The perforations may or may not extend through the reinforcements. For example, before the perforations are formed, reinforcing material may be applied to the areas of the second reflective film in which the perforations will be formed. Subsequently, the perforations may be made through the second reflective film and also through the reinforcements. In such implementations, the reinforcing material may or may not be substantially transparent. However, in implementations where the reinforcing material is substantially transparent, the perforations do not need to extend completely through the reinforcing material.

In alternative implementations, the reinforcements may be pre-formed to include holes. For example, the reinforcements may include doughnut-shaped elements that are applied after the perforations are formed. Depending on the type of material used to form such doughnut-shaped reinforcements, the holes of the reinforcements may or may not need to be aligned with the perforations. If the reinforcing material is not substantially transparent, it is generally desirable for the holes of the reinforcements to be aligned with, and substantially the same size as, the perforations.

In step 530, the second reflective film is attached to a second side of the frame. In some implementations, the second reflective film may be stretched across the second side of the frame in order to provide increased resistance to mechanical vibrations. In optional step 535, the second reflective film may be attached to the support struts, e.g., with an adhesive material. A light-turning film is then attached to the second reflective film. (Step 540.) In alternative implementations, the light-turning film is attached to the second reflective film before the second reflective film is attached to the frame. After a light source such as described above is attached to the window in the frame (step 545), the process ends. (Step 550.)

FIG. 6 is a block diagram that illustrates a control system 600 for determining the size and/or orientation of the perforations 115 in the front reflective layer, a perforation system for making the perforations and an assembly system for assembling at least part of a large-format backlight. For example, control system 600 may be configured to optimize the size and spacing of perforations 115 and/or other features of a backlight as described elsewhere herein. Logic system 605a may include one or more processors, programmable logic devices, etc. Logic system 605a may be configured to load and execute ray-trace simulation software that is stored in memory system 610a. The ray-trace simulation software may determine the irradiance in different parts of the backlight, the variation in theoretical irradiance, etc., according to data stored in memory system 610a and/or data input by, e.g., a user.

The backlight cavity dimensions, cavity reflectivity or reflectance data, the size and spacing of perforations 115, the effect of an indicated light-turning film, and/or other parameters of a desired backlight may be input via user interface system 602a, stored in memory system 610a and used for modeling by software executed via logic system 605a. User interface system 602a may include a keyboard, a mouse, one or more displays for presenting a graphical user interface and/or any other suitable user interface. The position and characteristics of a light source to be used by the backlight, as well as possible perforation sizes and configurations, may also be input via user interface system 602a. For example, the dimensions of light source 110, the number of light-providing elements of light source 110, the dimensions of the window 205 that is configured to receive light from light source 110, the optical characteristics of any associated mirrors, lenses, films (including but not limited to light-diffusing films) or other such apparatus associated with light source 110 and/or window 205 may be indicated. In some implementations, possible sizes, positions and optical characteristics of support struts may also be input via user interface system 602a.

Such data may also be received from another device, e.g., via network interface 620a or 620b. Input/output (“I/O”) system 615a supports communications between logic system 605a and other components, including network interfaces 620a and 620b. In this example, I/O system 615a is a bus-based system, but in alternative implementations I/O system 615a may have a different configuration, such as a crossbar-based configuration.

In some implementations, criteria for determining an acceptable illumination for a display may also be input via user interface system 602a and/or received via network interface 620a or 620b. A user may be able to input data pertaining to an acceptable variation in actual or theoretical irradiance of a display caused by backlight 105 via user interface system 602a. For example, the user may be able to specify the position of a plane in which the display would be disposed. The user may also be able to input a range of expected viewing angles, corresponding with whether the display would be at eye level, elevated above the viewers, etc. A range of desired angles for light emitted from the backlight may be specified, e.g., measured relative to a normal from the surface of front reflective layer 117.

The user may be able to input data, via user interface system 602a, for calculating the variation in theoretical irradiance across the plane in which the display will be positioned. For example, the user may be able to indicate one or more characteristics of grid cells within the plane, such as grid cell sizes, whether the grid cell sizes vary in different areas of the plane, etc. The user may be able to indicate whether data pertaining to grid cells in certain areas of the grid (such as edge areas) may be aggregated, smoothed, ignored or otherwise treated differently from data in other areas of the grid.

The user may be able to indicate how an acceptable variation in theoretical irradiance will be measured, e.g., whether by a maximum absolute difference, by a maximum gradient or other maximum rate of change across the grid, by a predetermined minimum value of a number that quantifies the uniformity of irradiance, etc. In addition to evaluating smoothness in local irradiance variations, factors involving human vision may be indicated. For example, the user may be able to indicate that a model that results in lighting that is brighter in the central portion of the display but dimmer near the edges may be acceptable, whereas a model that results in lighting that is dimmer in the central portion of the display and brighter near the edges may not be acceptable. The user may specify inflection points that could be objectionable to a human observer.

The user may also be able to input data regarding what should happen if the indicated variation in theoretical irradiance is determined to be unacceptable. In some implementations, the user will simply be notified of the result of a ray-tracing simulation and provided with data for evaluating the variation in theoretical irradiance. For example, after each ray-tracing simulation is performed, the user may be presented with data summarizing the backlight parameters used for the simulation and data indicating the results, such as a plot of irradiance over the area of the display, data indicating the light extraction efficiency, uniformity of the display illumination and/or other such data. The presentation of these data may be customized according to user input and displayed on one or more display screens of control system 600.

In alternative implementations, the process may be more automated. In some such implementations, a user may provide data indicating how parameters of the model may be changed if one or more criteria of a result exceed a predetermined threshold. For example, if the result of a ray-tracing simulation indicates that an area of the display (e.g., a cluster of grid cells) would receive less than a threshold level of irradiance, the number and/or size of perforations in that area may be increased according to predetermined criteria and another ray-tracing simulation may be performed. If a nearby area would receive more than a threshold level of irradiance, one or more perforations in that area may be shifted towards the area that received too little illumination. Given the same light source parameters and other backlight characteristics, whenever perforations are increased or enlarged to brighten one area, other areas will become darker.

Perforation system 625 is configured to form perforations 115 in a front reflective layer 117. The perforation type (e.g., whether or not the perforations extend through front reflective layer 117), the perforation size, spacing, etc., may be input to perforation system 625 via user interface system 602b and/or network interface 620c. These data may be stored in memory system 610b. Logic system 605b may be configured for controlling one or more devices of perforation system 625, at least in part according to data stored in memory system 610b.

Perforation system 625 may include one or more assemblies that are configured to form perforations 115. For example, perforation system 625 may include a mechanical die cutting assembly. Perforation system 625 may include an optical assembly configured to form perforations 115 via a laser cutting process.

As noted above, some implementations of front reflective layer 117 include a reflective layer and a substantially transparent layer. Perforation system 625 may include an etching assembly configured for selectively removing the reflective layer of front reflective layer 117 in the areas of the perforations, leaving only the substantially transparent layer in these areas.

In some implementations, perforation system 625 may be configured to apply reinforcements 215 or a reinforcing layer to front reflective layer 117, either before or after perforations 115 are formed. Moreover, in some implementations perforation system 625 may be configured to apply one or more light management elements, such as light-turning film 125, to front reflective layer 117. In alternative implementations, reinforcements 215 and/or light management elements may be added to front reflective layer 117 by assembly system 630.

Assembly system 630 may be configured to manufacture backlights 105 such as those described herein. Backlight manufacturing criteria may be input to assembly system 630 via user interface system 602c and/or network interface 620d. Such data may be stored in memory system 610c. Logic system 605c may be configured for controlling one or more devices of assembly system 630, at least in part according to data stored in memory system 610c. For example, logic system 605c may be configured for controlling one or more devices of assembly system 630 to perform the steps of method 500 or other methods described herein.

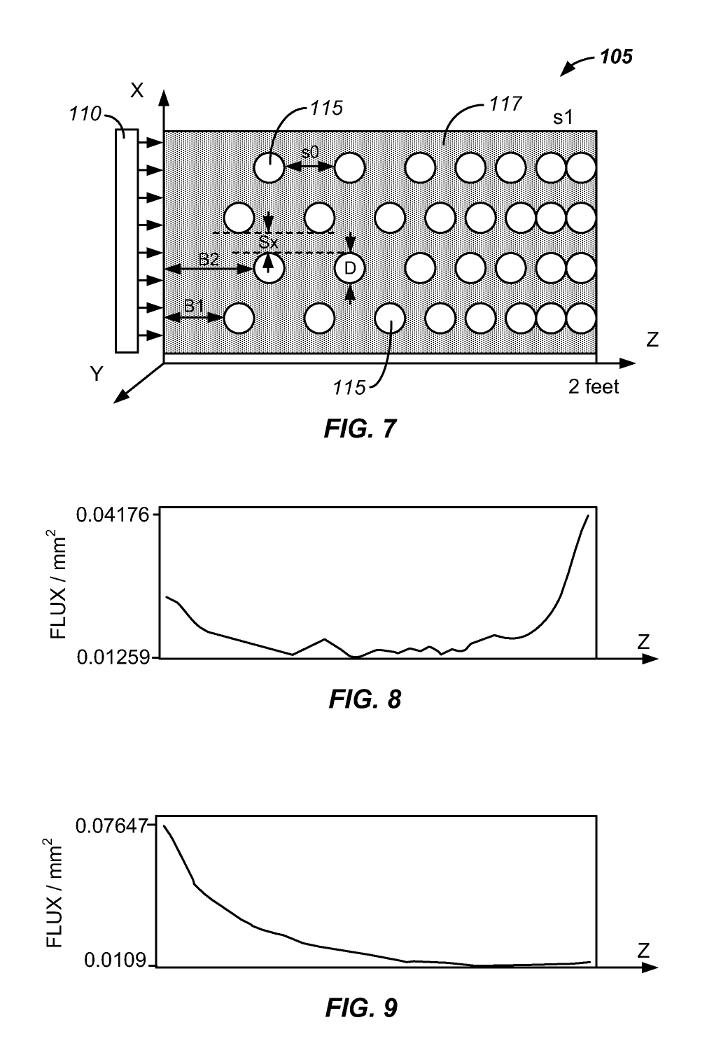

Some examples of designing parameters of a backlight and of modeling such parameters will now be described with reference to FIGS. 7 through 11B. FIG. 7 depicts dimensions and other parameters that may be used as input for simulations of a backlight as described herein. Light source 110 is schematically depicted along a first side of the simulated back light 105. All simulations depicted herein are based on the same orientation of light source 110.

Various parameters involving the size and distribution of perforations 115 are also indicated. D indicates the diameter of perforations 115. Although a single value of D is used in the simulations depicted herein, alternative implementations allow a user to select more than one diameter for perforations 115 to be used in a simulation. B1 indicates the distance from the left border of the simulated backlight to the leftmost dot in the first row, whereas B2 indicates the distance from the left border to the leftmost dot in the second row. Sₓ indicates the distance between the dot rows.

In this example, a space function is defined as follows:

S(z)=s0+(s1−s0)*(z−1)/(N_{z}−1)^{k} [Equation 1.]

Here, s0 is the initial distance between perforations and s1 is the final distance between perforations. N_{z} is the number of perforations in one row within the length of the backlight (along the z axis), which is 2 feet in this example. In this example, k is the power of the space function. Various other parameters may be used as input parameters, such as the spacing of individual lights within light source 110. In this example, the “s” parameter is monotonically decreasing from left to right. It is to a great extent due to this limitation that our model results peak at the edges. In alternative implementations the “s” value may vary in a different manner, e.g., the “s” value in the central portion of the backlight may be smaller than the “s” value at either end of the backlight. Some such implementations are described below.

FIG. 8 depicts modeling results of a first backlight simulation based on a first set of parameters. In this example, the simulated backlight was 2 feet long, one inch thick (along the y axis) and 200 mm wide (along the x axis). The value of D was set to 1 mm, k was set to 1, N_{z} was 67, s0 was 15 mm and s1 was set to 1 mm.

In the graph of FIG. 8, the z axis corresponds to that of FIG. 7 and represents distance along the length of the simulated backlight. The vertical axis of FIG. 8 indicates the flux per square millimeter, as measured in a plane parallel to side 117 of the backlight. In this example, the results suggest that the initial spacing is too large and/or the final spacing is too small: the flux is too high at the far end of the backlight (away from the light source), as compared to the flux near the light source. Moreover, the flux in the middle portion of the backlight is unacceptably low. In this simulation, the light extraction efficiency of this backlight was approximately 72% and the uniformity was approximately 5%.

FIG. 9 depicts modeling results of a second backlight simulation based on a second set of parameters. In this example, most parameters were held constant: the simulated backlight was 2 feet long, one inch thick and 200 mm wide. The value of D was set to 1 mm, k was set to 1 and s1 was set to 1 mm. However, the initial perforation spacing s0 was reduced to 3 mm, in order to allow more light to escape from the backlight near the light source. N_{z} was increased to 205.

This configuration did allow more light to escape from the backlight near the light source. However, in this instance the flux was too great near the light source and too low everywhere else. This suggests that the initial perforation spacing s0 was too small. Moreover, so much light had escaped from the backlight by the time the light had traversed even one length (from light source 110 to the maximum z value) that there was very little flux at the far end. This suggests that there were too many perforations and/or that they were too large. In this simulation, the light extraction efficiency of this backlight was almost 89%, which is 18% greater than that of the previous simulation. However, the uniformity was only about 1%, which is even worse than the 5% uniformity of the prior simulation.

The parameters, i.e., the third set of parameters, used to prepare the next simulation were adjusted accordingly. Again, most parameters were held constant. However, the initial perforation spacing s0 was increased to 7 mm and N_{z} was reduced to 120, in order to allow more light to reach the far end of the backlight.

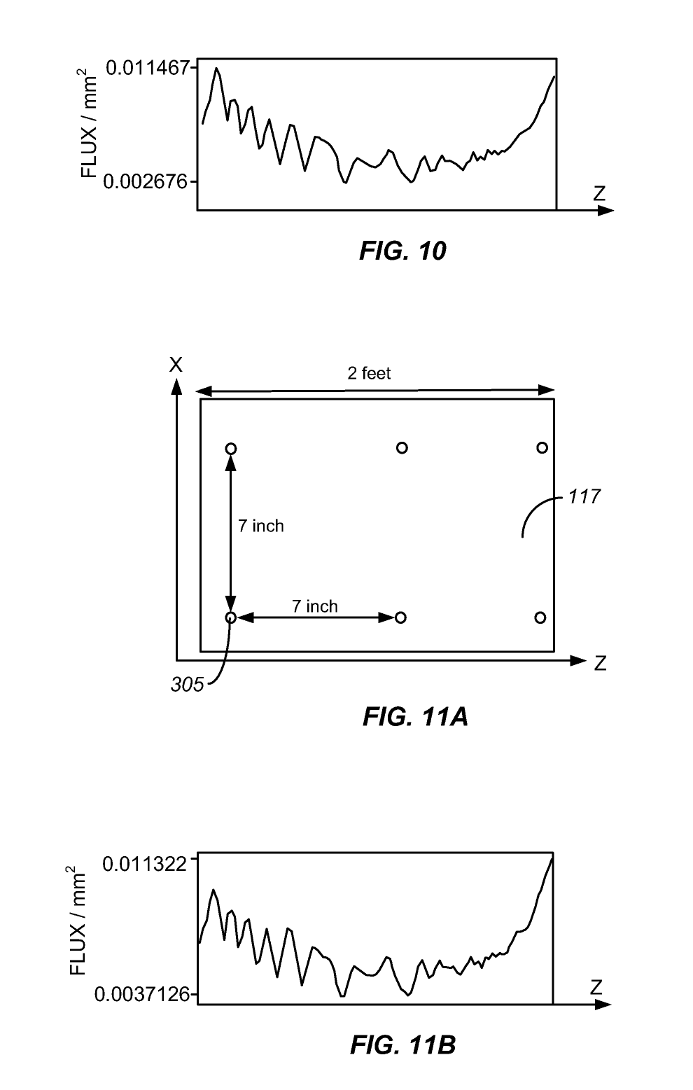

FIG. 10 depicts modeling results of a third backlight simulation based on a third set of parameters. In this simulation, the light extraction efficiency was about 62%, which is 27% less than that of the previous simulation. However, the uniformity was more than 50%, which is a dramatic improvement over the prior simulations. In this example, a uniformity of irradiance above 50% was considered to be acceptable.

However, in other implementations a higher uniformity of irradiance may be desired. In such implementations, simulation parameters may be refined until the uniformity of irradiance is above 55%, above 60%, etc. The results indicated in FIG. 10 provide guidance as to how the simulation parameters could be further refined to produce a more uniform illumination of a display. For example, many observers may find the lower flux in the middle of the display and the higher flux at the edges of the display to be unsatisfactory. Moreover, the high flux at the far end of the display indicates that too much light is reaching the far end and reflecting back.

Both of these factors suggest that if the perforations have a uniform size, having the perforation spacing reach a minimum when z is at a maximum (at the far end of the backlight relative to the light source) is not an optimal configuration. If the perforation spacing were to decrease with increasing z, reach a minimum value, and then increase until z reaches a maximum value Zₘₐₓ (at the far end), more light would be extracted in the central portion of the backlight and less light would be extracted from both the near and far ends of the backlight. Taking into consideration the observed effects of reflection from the far end of the backlight, the minimum perforation spacing may be reached between the middle of the backlight and the far end of the backlight, e.g., at ⅔ of Zₘₐₓ or ¾ of Zₘₐₓ. The value of z corresponding to the minimum perforation spacing, as well as the minimum perforation spacing itself, the number of perforations, etc., could be determined by additional simulations. The process may end after a simulated backlight is configured to provide illumination having a uniformity that is within a predetermined range and has acceptable characteristics according to the perception of human observers, as discussed above.

As discussed above with reference to FIG. 3, some backlights provided herein may include support struts 305 to provide structural support for front reflective layer 117. FIG. 11A depicts a backlight having internal support struts. In the example depicted in FIG. 11A, simulated support struts 305 include substantially transparent cylinders having a length of one inch, equal to the simulated backlight's thickness. Simulated support struts 305 extend from back reflective layer 210 (not shown in FIG. 11A) to front reflective layer 117, are spaced 7 inches apart and have an index of refraction of 1.489 in this example. All other parameters are substantially the same as those used in the simulation described above with reference to FIG. 10.

FIG. 11B depicts modeling results of a fourth backlight simulation based on a fourth set of parameters, including parameters for the internal support struts depicted in FIG. 11A. By comparing FIG. 11B with FIG. 10, it may be seen that the flux distribution was substantially the same with or without the simulated support struts 305. Adding the simulated support struts 305 changed the uniformity and light extraction efficiency by less than 1%.

Some alternative implementations provide a five-sided backlight 105 rather than the six-sided backlight 105 shown, e.g., in FIG. 1 and FIG. 2. In such implementations, the display being illuminated may be attached to light management element(s), such as light-turning film 125, that are attached to front reflective layer 117. In such implementations, the display assembly could include a film to be illuminated, one or more light management elements and front reflective layer 117. The five-sided backlight 105 may be assembled separately from the display assembly.

Moreover, although the backlights illustrated herein have a light source on only one side, alternative backlights include light sources on two or more sides. For example, some backlights provided herein have two instances of light source 110. One instance of light source 110 may be positioned substantially as shown herein (e.g., in FIG. 1) and another instance of light source 110 may be positioned on the opposite side, on the top side or on the bottom side.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the present disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A backlight, comprising:
a first side having a first width and configured to receive light from a light source;
second, third and fourth sides having substantially the first width, the first through fourth sides forming a substantially rigid frame, the second through fourth sides having reflective interior surfaces that are configured to reflect light from the light source;
a first reflective film attached to a first side of the frame; and
a second reflective film attached to a second side of the frame, the second reflective film having a plurality of perforations, wherein the first and second reflective film define a cavity within the frame, the size and spacing of the perforations being configured for producing a field of light for a display via the plurality of perforations, the field of light having a uniformity of irradiance that exceeds a threshold level.

2. The backlight of claim 1, further comprising a light-turning film configured to re-direct at least some light that emerges from the perforations in the second reflective film.

3. The backlight of claim 1, further comprising a plurality of support struts affixed to the first reflective film and extending between the first and second reflective films.

4. The backlight of claim 1, wherein a first side of the second reflective film is attached to the second side of the frame and a second side of the second reflective film faces away from the frame, further comprising a diffusing film disposed proximate the second side of the second reflective film.

5. The backlight of claim 1, wherein the size and spacing of the perforations are further configured to achieve at least a threshold level of light extraction from a cavity formed by the backlight.

6. The backlight of claim 1, further comprising reinforcing material on edges of at least some perforations.

7. A display that includes the backlight of claim 1.

8. The backlight of claim 1, further comprising the light source.

9. The backlight of claim 1, further comprising a substantially transparent sheet of reinforcing material affixed to the second reflective film.

10. The backlight of claim 2, wherein the light-turning film is configured to re-direct at least some light that emerges from the perforations such that the light emerges from the light-turning film along an axis that is substantially perpendicular to the second reflective film.

11. The backlight of claim 2, further comprising a diffusing film, wherein the light-turning film is disposed between the diffusing film and the second reflective film.

12. The backlight of claim 3, wherein the support struts are substantially transparent.

13. The backlight of claim 3, wherein the support struts are affixed to the second reflective film.

14. A method, comprising:
assembling a four-sided frame having reflective inner surfaces, one side of the frame having a window configured to receive light from a light source;
attaching a first reflective film to a first side of the frame;
forming a plurality of perforations in a second reflective film; and
attaching the second reflective film to a second side of the frame,
wherein the forming comprises forming the perforations such that a field of light emanating from the plurality of perforations has a uniformity of irradiance that exceeds a threshold level.

15. The method of claim 14, further comprising attaching a light-turning film to an exterior surface of the second reflective film, the light-turning film configured to re-direct at least some light that emerges from the perforations.

16. The method of claim 14, further comprising affixing a plurality of support struts to the first reflective film.

17. The method of claim 14, wherein the forming comprises forming the perforations to achieve at least a predetermined level of light extraction from a cavity formed by the frame, the first reflective film and the second reflective film.

18. The method of claim 14, wherein the forming comprises a mechanical cutting process.

19. The method of claim 14, wherein the forming comprises a laser cutting process.

20. The method of claim 14, wherein the forming comprises an etching process.

21. The method of claim 14, wherein the forming comprises forming perforations that extend through only a portion of the second reflective layer.

22. The method of claim 14, further comprising applying reinforcing material to at least some perforations.

23. The method of claim 14, further comprising attaching a light source to the window.

24. A backlight formed according to the method of claim 14.

25. The method of claim 15, further comprising disposing a diffusing film adjacent to the light-turning film.

26. The method of claim 15, wherein the light-turning film is configured to re-direct at least some light that emerges from the perforations such that the light emerges from the light-turning film along an axis that is substantially perpendicular to the second reflective film.

27. The method of claim 16, further comprising attaching the second reflective film to the support struts.

28. The method of claim 22, wherein the applying comprises attaching substantially transparent disks of reinforcing material to at least some perforations.

29. The method of claim 22, wherein the applying comprises attaching a substantially transparent layer of reinforcing material to the second reflective film.

30. A tangible medium having software stored thereon, the software comprising instructions for controlling at least one device to form a plurality of perforations in a first reflective film such that a field of light emanating from a backlight through the plurality of perforations has a uniformity of irradiance that exceeds a threshold level.

31. The tangible medium of claim 30, wherein the software comprises instructions for controlling at least one device to perform the following operations:
assemble a four-sided frame having reflective inner surfaces, one side of the frame having a window configured to receive light from a light source;
attach the first reflective film to a first side of the frame; and
attach a second reflective film to a second side of the frame.

32. The tangible medium of claim 30, wherein the software comprises instructions for controlling at least one device to affix a plurality of support struts to the first reflective film.

33. The tangible medium of claim 31, wherein the software comprises instructions for controlling at least one device to attach a light-turning film to an exterior surface of the first reflective film, the light-turning film configured to re-direct at least some light that emerges from the perforations.

34. An apparatus, comprising:
means for assembling a four-sided frame having reflective inner surfaces, one side of the frame having a window configured to receive light from a light source;
means for attaching a light source to the window;
means for forming a plurality of perforations in a first reflective film; and
means for attaching the first reflective film to a first side of the frame and for attaching the second reflective film to a second side of the frame,
wherein the forming means comprises means for forming the plurality of perforations such that a field of light emanating from the plurality of perforations has a uniformity of irradiance that exceeds a threshold level.

35. The apparatus of claim 34, wherein the attaching means comprises means for attaching a light-turning film to an exterior surface of the first reflective film, the light-turning film configured to re-direct at least some light that emerges from the perforations.

36. The apparatus of claim 34, further comprising means for affixing a plurality of support struts to the second reflective film.
